(19) United States
(12) Patent Application Publication
(10) Pub. No.: US 2015/0166218 A1
(43) Pub. Date: Jun. 18, 2015

(54) MULTI-CARD PACKAGE AND METHOD OF MAKING THE SAME

(71) Applicant: Harvard Label, Inc. dba Harvard Card Systems, City of Industry, CA (US)

(72) Inventor: David Banducci, City of Industry, CA (US)

(73) Assignee: Harvard Label, Inc. dba Harvard Card Systems, City of Industry, CA (US)

(21) Appl. No.: 14/108,178

(22) Filed: Dec. 16, 2013

(51) Int. Cl. B65D 8/00; G06K 19/00

(52) U.S. Cl. CPC B65D 15/22; G06K 19/005

(57) ABSTRACT

A stored-value card multipack includes a plurality of stored-value cards having a mechanical security mechanism. The stored-value card multipack is configured to prevent fraud and theft of the stored-value cards by revealing evidence of tampering. In one embodiment, the stored-value card multipack includes a carrier shell coupled to a carrier base. Together, the carrier shell and the carrier base define a cavity. A first card is housed in the cavity and a second card is detachably coupled to the carrier shell by a mechanical security mechanism. The second card extends out of the cavity and thereby exposes a readable code on the second card.

### FIELD

The present application relates generally to card packages, and more particularly to card multipacks having a security mechanism.

### BACKGROUND

Stored-value cards are preloaded with a predetermined cash value that is redeemable for the rental or purchase of a variety of goods and services. Stored-value cards may be used as a replacement or supplement to cash and/or credit cards. Additionally, stored-value cards are commonly purchased and distributed as gift cards for special occasions, such as birthdays, holidays, or as employee appreciation rewards. Stored-value cards may be industry or retailer specific (e.g., transit system cards, telephone cards, restaurant cards, cinema cards) or unrestricted (i.e., the stored-value card may be used at any establishment accepting such cards). Stored-value cards are typically displayed for sale in retail stores, such as grocery stores and department stores, and purchased by individuals.

Merchants of stored-value cards typically sell non-activated, “zero-balance” stored-value cards which must be activated at the merchant's checkout register, such as by a magnetic, bar code, and/or radio frequency card reader. After the card is activated, the stored-value card may be redeemed for a preset cash value or a value selected by the purchaser at the time of purchase. That is, upon sale of a stored-value card to a purchaser, the merchant electronically activates the stored-value card with a balance paid for by the purchaser, and then the purchaser may redeem the balance on the stored-value card at a retailer by swiping a magnetic stripe on the card, using a radio-frequency identification reader, or by entering code number on the card into a numeric keypad. A database containing activation codes and balance data is typically maintained by a processing company, which is notified electronically by the merchant when the card has been activated. Alternatively, the processing company may perform the activation of the particular card upon receiving an electronic message from the merchant that the card has been purchased.

Selling non-activated, zero-balance cards reduces the merchant's risk of loss due to fraud or theft of the stored-value cards. Additionally, selling non-activated, zero-balance cards reduces the merchant's overhead because the value of the inactivated cards is typically not payable to the wholesale vendor of the cards until the cards are activated by the merchant at the point of sale. Moreover, stored-value cards are typically sold mounted on, or housed in, a card carrier and/or protective display package in an effort to reduce the merchant's risk of loss due to fraud or theft of the cards. However, conventional stored-value cards are susceptible to theft and/or fraud due to tampering of the card carrier and/or protective display packaging.

Additionally, it is common for individuals to purchase more than one stored-value card in a single purchase. Accordingly, stored-value multipacks (i.e., display packages containing multiple cards) have been created. Such multipacks allow a purchaser to purchase more than one card in a single purchase, such as several cards each having relatively lower redemption values as compared to a single stored-value card having a relatively high redemption value. However, there are additional complexities in the packaging, activation, data-keeping, and fraud protection of such stored-value card multipacks, and one or more of these tasks is typically performed manually during the manufacturing process of the stored-value card multipacks, which may enable fraud and theft during the manufacturing process. For instance, the bar codes on the individual stored-value cards may be copied by unscrupulous individuals and reproduced on duplicate cards.

Accordingly, conventional stored-value cards are susceptible to fraud and theft, both at the point of sale and during the manufacturing process. As such, there is a need for a stored-value card package configured to prevent fraud and reveal evidence of tampering with the stored-value card packaging.

### SUMMARY

The present invention is directed to various embodiments of stored-value card multipacks having a security mechanism. In one embodiment, the stored-value card multipack includes a carrier base, a carrier shell coupled to the carrier base, a first card housed in a cavity defined by the carrier base and the carrier shell, and a second card detachably coupled to the carrier shell by a mechanical security mechanism. A portion of the second card extends out of the cavity, thereby exposing a readable code on the second card. In one embodiment, the mechanical security mechanism includes a security post protruding from the carrier shell and an aperture in the second card configured to detachable receive the security post. The security post may have any suitable shape, such as a circular cylinder, an oval cylinder, a square prism, a rectangular prism, a pyramid, or even an irregular shape. In another embodiment, the mechanical security mechanism includes a notch in the carrier shell and a pair of opposing notches in the second card. The pair of opposing notches in the second card define a necked portion configured to be detachably received in the notch in the carrier shell.

In one embodiment, the first card is a child stored-value card and the second card is a parent-stored value card. Balances associated with the child stored-value card and the parent stored-value card are linked by a data file such that activation of the parent stored-value card automatically activates the child stored-value card. In one embodiment, the second card includes a body portion and a detachable tab portion extending from the body portion. The detachable tab portion is configured to be housed in the cavity and the body portion is configured to be located outside of the cavity. The readable code on the second card may be a bar code, a magnetic stripe, a radio-frequency identification card, or an alphanumeric sequence.

In one embodiment, the carrier base includes a front portion coupled to a rear portion, and the front portion of the carrier base includes an opening configured to receive the carrier shell. When the stored-value card multipack is assembled, a portion of the second card is disposed between the front and rear portions of the carrier base. In one embodiment, the carrier shell includes a peripheral flange and a recessed portion projecting from the peripheral flange. The recessed portion of the carrier shell projects through the opening in the carrier base and the peripheral flange on the carrier shell is disposed between the front and rear portions of the carrier base. In another embodiment, the carrier shell and the carrier base are integral. In one embodiment, the carrier shell is configured to tilt the first card at an angle relative to the carrier base. In another embodiment, the carrier shell includes at least one step. In yet another embodiment, the stored-value card multipack includes a plurality of cards housed in the carrier shell and arranged in a stacked configuration.

In another embodiment, the stored-value card multipack includes a carrier base, a carrier shell coupled to the carrier base, a first card housed in a cavity defined by the carrier shell and the carrier base, and a second card detachably coupled to the carrier shell by a mechanical security mechanism. A portion of the second card extends out of the cavity, thereby exposing a readable code on the second card. The mechanical security mechanism includes a security post protruding from the carrier shell, an aperture in the second card configured to detachable receive the security post, a notch in the carrier shell, and a pair of opposing notches in the second card defining a necked portion configured to be detachably received in the notch in the carrier shell. In one embodiment, the second card includes a body portion and a detachable tab portion extending from the body portion. The detachable tab portion of the second card is configured to be housed in the cavity and the body portion is configured to be located outside of the cavity.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and other features and advantages of embodiments of the present invention will become more apparent by reference to the following detailed description when considered in conjunction with the following drawings. In the drawings, like reference numerals are used throughout the figures to reference like features and components. The figures are not necessarily drawn to scale.

FIG. 1 is an exploded rear perspective view of a stored-value card multipack according to one embodiment of the present invention;

FIG. 2 is a rear perspective view of the embodiment of the stored-value card multipack illustrated in FIG. 1 shown in a partially assembled state;

FIG. 3 is a front view of the embodiment of the stored-value card multipack illustrated in FIG. 2;

FIG. 4 is a cross-sectional view of the embodiment of the stored-value card multipack illustrated in FIG. 3;

FIGS. 5A, 5B, and 5C are an exploded rear perspective view, a front view, and a cross-sectional view, respectively, of a stored-value card multipack according to another embodiment of the present invention;

FIG. 6 is a cross-sectional view of the stored-value card multipack according to a further embodiment of the present invention;

FIG. 7 is a cross-sectional view of the stored-value card multipack according to yet another embodiment of the present invention;

FIG. 8 is a flowchart illustrating a method of assembling a stored-value card multipack according to one embodiment of the present invention.

### DETAILED DESCRIPTION

The present invention relates to stored-value card multipacks. The stored-value card multipacks of the present invention are configured to enable convenience activation of the stored-value cards. Additionally, the stored-value card multipacks of the present invention are configured to prevent fraud and theft of the stored-value cards by revealing evidence of tampering.

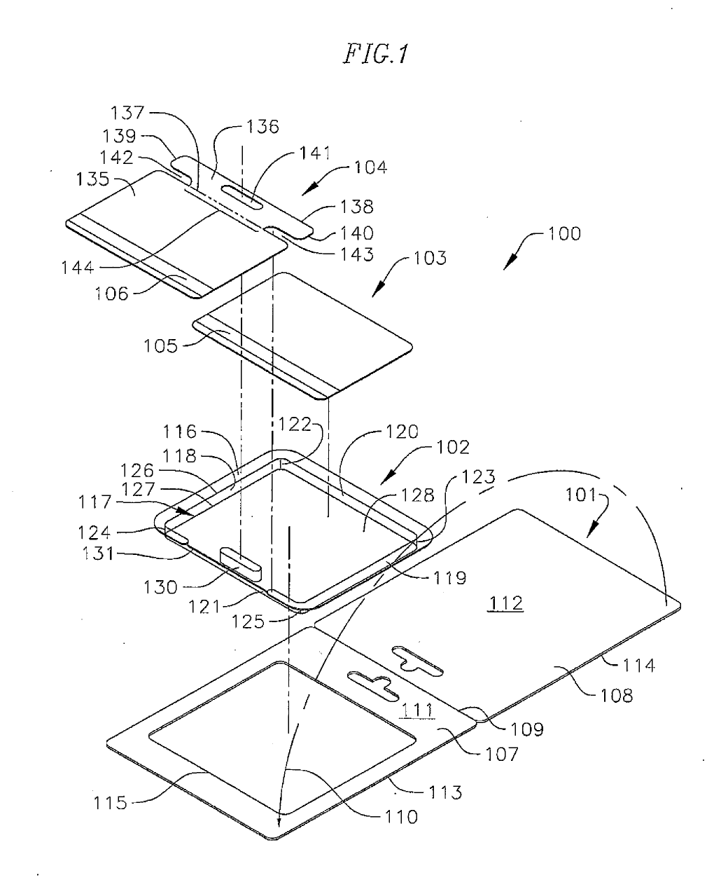

With reference now to FIG. 1, a stored-value card multipack 100 according to one embodiment of the invention is illustrated in an unassembled state. The stored-value card multipack 100 includes a carrier base 101, a carrier shell 102, and a plurality of stored-value cards 103, 104.

As used herein, the term “stored-value cards” refers to any card having a redeemable balance stored thereon or associated with the card, including, but not limited to, gift cards, prepaid credit or debit cards, prepaid phone cards, and prepaid transit system cards. The stored-value cards in the stored-value card multipack 100 include at least one child card 103 and one parent card 104. The at least one child card 103 and the parent card 104 each include a readable code 105, 106 respectively, such as, for instance, a barcode, a magnetic stripe, a radio-frequency identification (RFID) chip, or an alphanumeric character sequence. The readable codes 105, 106 on the stored-value cards 103, 104 store data relating to the remaining balance associated with the card. In one embodiment, a data file links or associates the readable code 106 on the parent card 104 with the readable codes 105 on each of the child cards 103. The data file linking the readable codes 105, 106 and the associated balances on the stored-value cards 103, 104 is typically maintained by a data processing company. Accordingly, when the parent card 104 is activated (e.g., by swiping the magnetic stripe 106 on the parent card 104 at the time of purchase), each of the child cards 103 linked or associated with the parent card 104 are also automatically activated without requiring separate activation of each of the child cards 103. Following activation of the stored-value cards 103, 104, the purchaser may redeem the balance on the stored-value cards 103, 104 at any participating retailer by reading the readable codes 105, 106 on the cards 103, 104 (e.g., swiping the magnetic stripe through a magnetic card reader, scanning the RFID chip with an RFID chip reader, scanning the barcode, or entering the alphanumeric sequence into a keypad).

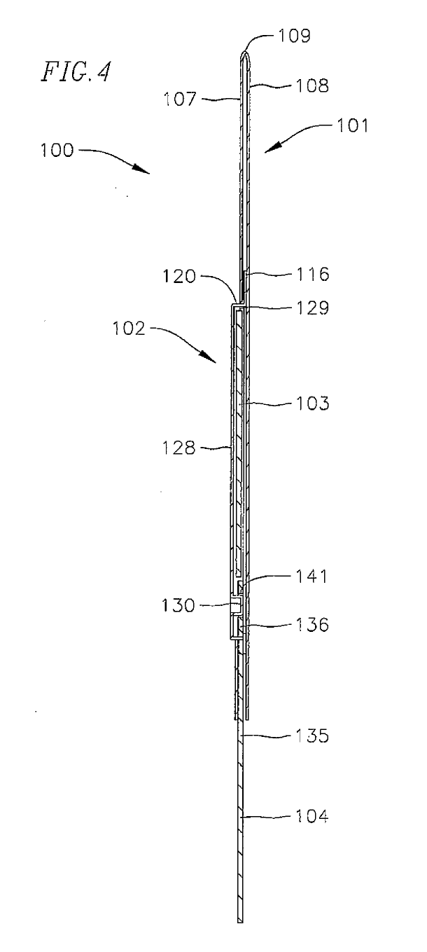

With continued reference to the embodiment illustrated in FIG. 1, the carrier base 101 is illustrated in an unfolded position. The carrier base 101 includes a front portion 107 and a rear portion 108 separated by a fold line 109. The fold line 109 defines a hinge about which the rear portion 108 of the carrier base 101 is configured to rotate (arrow 110) into a closed position (see FIG. 4). The front and rear portions 107, 108 include inner surfaces 111, 112, respectively, and outer surfaces 113, 114, respectively, opposite the inner surfaces 111, 112. The carrier base 101 may include various printed indicia, such as, for example, ornamentation (e.g., graphics and designs), advertising, instructions, and/or terms of use of the stored-value cards 103, 104. In one embodiment, for instance, the outer surfaces 113, 114 of both the front and rear portions 107, 108 of the carrier base 101 may include printed indicia. Although the carrier base 101 is illustrated as a single member having front and rear portions 107, 108 separated by a fold line 109, in an alternate embodiment, the carrier base 101 may include separate front and rear carrier base members configured to be joined together.

The front portion 107 of the carrier base 101 also includes an opening 115 configured to receive a portion of the carrier shell 102, as described in further detail below. In the illustrated embodiment, the opening 115 is generally square, although it will be appreciated that the opening 115 in the front portion 107 of the carrier base 101 may have any other suitable shape, such as, for example, rectangular, circular, or may even be irregularly shaped. In one embodiment, the shape of the opening 115 in the carrier base 101 generally matches the shape of the carrier shell 102, described below. However, the shape of the opening 115 in the carrier base 101 may be different than the shape of the carrier shell 102 and still fall within the scope and spirit of the present invention. For instance, the opening 115 in the carrier base 101 may be sized and/or shaped to provide an ornamental frame or border around the child stored-value cards 103 housed in the carrier shell 102.

With continued reference to the embodiment illustrated in FIG. 1, the carrier shell 102 is configured to house the at least one child stored-value card 103 and a portion of the parent stored-value card 104. The carrier shell 102 includes a peripheral flange or lip 116 and a recessed portion 117 protruding from the peripheral flange 116. In the illustrated embodiment, the recessed portion 117 of the carrier shell 102 is defined by two opposing side panels 118, 119 extending in a longitudinal direction and two opposing upper and lower panels 120, 121, respectively, extending in a direction transverse to the longitudinal direction. The upper panel 120 extends between and interconnects upper ends 122, 123 of the side panels 118, 119, respectively, and the lower panel 121 extends between and interconnects lower ends 124, 125 of the side panels 118, 119, respectively. Together, the side panels 118, 119 and the upper and lower panels 120, 121 define a generally rectangular carrier shell 102. Each of the wall segments 118, 119, 120,121 includes an inner end 126 coupled to the peripheral flange 116 and an outer end 127 opposite the inner end 126. The recessed portion 117 of the carrier shell 102 also includes a front panel 128 extending between the outer ends 127 of the wall segments 118, 119, 120,121. When the stored-value card multipack 100 is assembled, as illustrated in FIG. 4, the recessed portion 117 of the carrier shell 102 and the rear portion 108 of the carrier base 101 cooperate to define a cavity 129 configured to house the one or more child stored-value cards 103 and at least a portion of the parent stored-value card 104. One or more of the child stored-value cards 103 may also be secured in the recessed portion 117 of the carrier shell 102 by a releasable adhesive.

Still referring to FIG. 1, the carrier shell 102 may also include one or more security mechanisms configured to releasably secure the parent stored-value card 104 to the carrier shell 102. The one or more security mechanisms are configured to inhibit and/or deter theft of the parent stored-value card 104. In the illustrated embodiment, a first security mechanism includes a security post 130 configured to securedly attach the parent stored-value card 104 to the carrier shell 102, as described in more detail below. The security post 130 projects rearward from the front panel 128 of the carrier shell 102. Although in the illustrated embodiment the security post 130 is an oval cylinder, the security post may have any other suitable shape, such as, for example, a circular cylinder, a square prism, a rectangular prism, a pyramid, or even an irregular shape. The carrier shell 102 may also include a second security mechanism configured to secure the parent stored-value card 104 to the carrier shell 102. In the illustrated embodiment, the second security mechanism includes a notch 131 extending along at least a portion of the lower panel 121 and the peripheral flange 116 of the carrier shell 102. The portion of the notch 131 in the peripheral flange 116 is aligned with the portion of the notch 131 in the lower panel 121. As described in more detail below, a portion of the parent card 104 is configured to engage the notch 131 in the carrier shell 102.

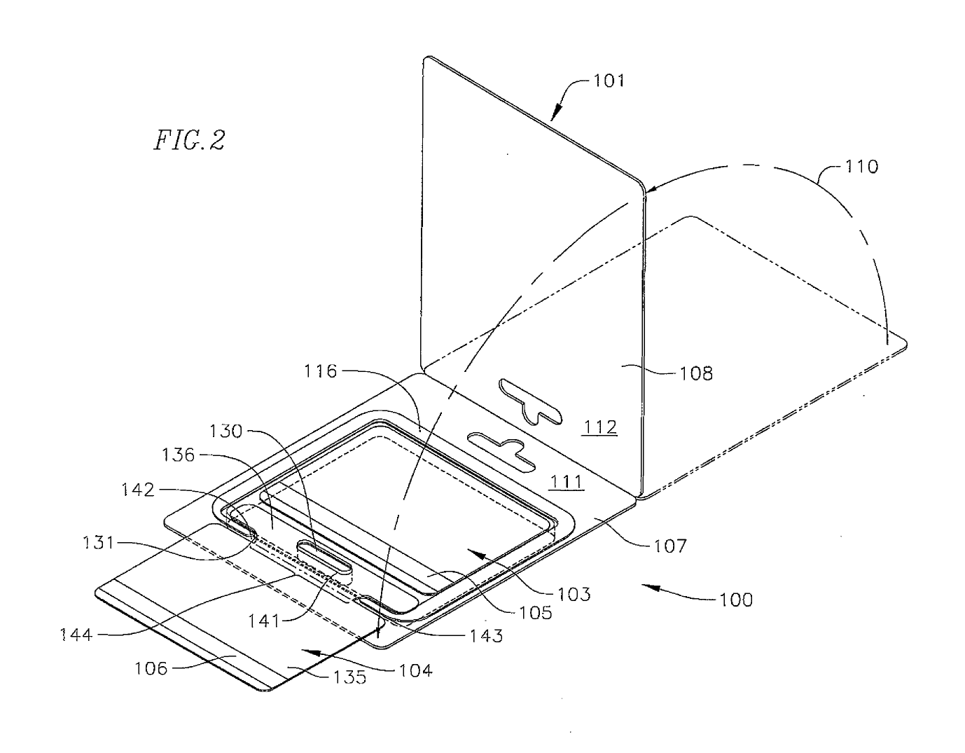

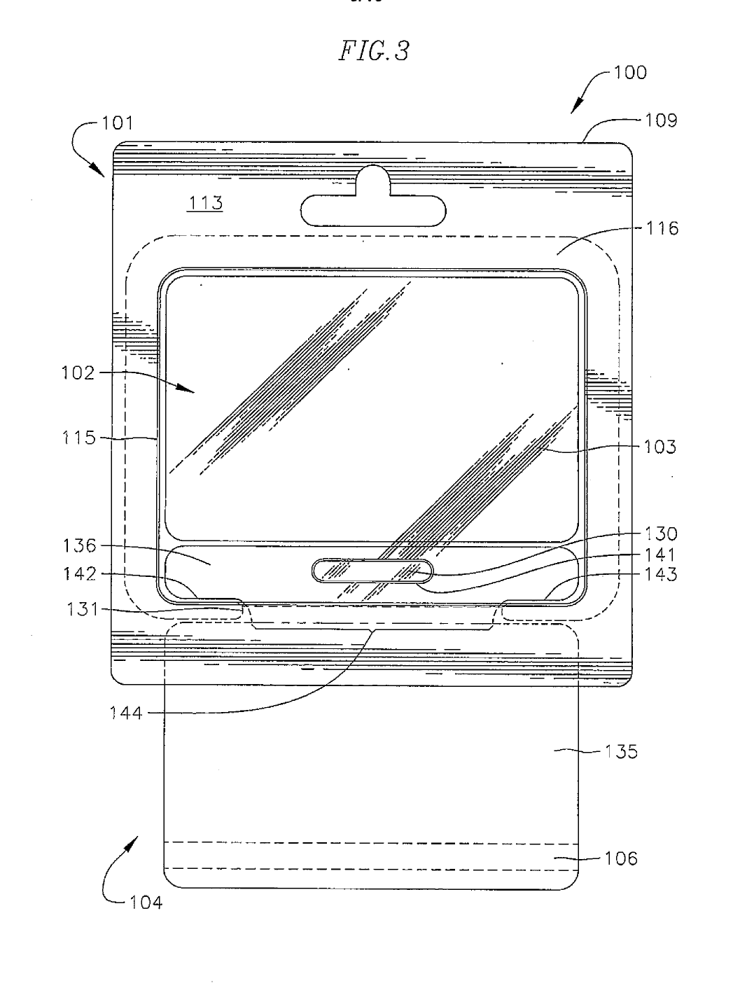

In the illustrated embodiment of FIG. 1, the parent stored-value card 104 includes a body portion 135 and a detachable tab portion 136 extending from the body portion 135. In the illustrated embodiment, the detachable tab portion 136 of the parent stored-value card 104 includes a pair of longitudinal edges 137, 138 and a pair of transverse edges 139, 140 defining a generally rectangular detachable tab 136. It will be appreciated, however, that the detachable tab portion 136 of the parent stored-value card 104 may have any other suitable shape, such as, for example, square or circular, and still fall within the scope and spirit of the present invention. In one embodiment, the shape and size of the body portion 135 of the parent stored-value card 104 are the same or similar to the one or more child stored-value cards 103. As illustrated in FIG. 2, the detachable tab portion 136 is configured to be housed in the carrier shell 102 and the body portion 135 is configured to extend out from the carrier shell 102 through the notch 131 in the carrier shell 102, thereby exposing the readable code 106 (e.g., barcode, magnetic stripe) on the parent stored-value card 104 (i.e., the body portion 135 of the parent stored-value card 104 is located outside of the carrier shell 102). Exposing the readable code 106 on the parent stored-value card 104 enables the merchant to easily and readily activate the parent stored-value card 104 and the associated or linked child stored-value cards 103 housed in the carrier shell 102 (i.e., exposing the readable code 106 on the parent stored-value card 104 enables the merchant to activate the parent stored-value card 104 without having to first remove the cards from the carrier shell 102).

With continued reference to FIGS. 1 and 2, the detachable tab portion 136 of the parent stored-value card 104 also includes an aperture 141 configured to be detachably coupled to the security post 130 on the carrier shell 102 (i.e., the security post 130 is configured to extend through the aperture 141 in the detachable tab portion 136 of the parent stored-value card 104, thereby securing the parent stored-value card 104 to the carrier shell 102). The aperture 141 in the detachable tab portion 136 of the parent card 104 may have any suitable shape, such as, for example, circular, square, rectangular, or elliptical. In the illustrated embodiment, the shape and size of the aperture 141 in the parent card 104 substantially matches the shape and size of the security post 130 on the carrier shell 102. As used herein, the term “substantially” is used as a term of approximation and not as a term of degree, and is intended to account for the inherent deviations in measured or calculated values that would be recognized by those of ordinary skill in the art. Accordingly, as used herein, the term “substantially matches the shape and size” and similar terms are used as terms of approximation to denote that the shape and size of the aperture 141 and the security post 130 match and any deviations are negligible. Together, the aperture 141 in the parent stored-value card 104 and the security post 130 define the first security mechanism.

With continued reference to the embodiment illustrated in FIGS. 1 and 2, the parent stored-value card 104 also includes a pair of opposing notches 142, 143. In the illustrated embodiment, the notches 142, 143 extend inward from the transverse edges 139, 140, respectively, a distance along the lower longitudinal edge 137 of the detachable tab portion 136 of the parent stored-value card 104. Together, the notches 142, 143 define a necked or tapered portion 144 of the parent stored-value card 104. In the illustrated embodiment, the width of the necked portion 144 of the parent card 104 is substantially equal to the width of the notch 131 in the carrier shell 102. In another embodiment, the width of the necked portion 144 of the parent card 104 is less than the width of the notch 131 in the carrier shell 102. When the stored-value card multipack 100 is assembled, the necked portion 144 of the parent stored-value card 104 is received in the notch 131 in the carrier shell 102 such that portions of the lower panel 121 of the carrier shell 102 extend into the notches 142, 143 in the parent stored-value card 104, as illustrated in FIG. 2. Additionally, the width of the detachable tab portion 136 of the parent card 104 is wider than the width of the notch 131 in the carrier shell 102 such that the detachable tab portion 136 of the parent stored-value card 104 is retained in the carrier shell 102 (i.e., the detachable tab portion 136 of the parent stored-value card 104 cannot pass through the narrower notch 131 in the carrier shell 102). The notches 142, 143 in the parent stored-value card 104 may have any suitable length, such as, for example, approximately 11/16 inch. Additionally, the width of the necked portion 144 of the parent stored-value card 104 may have any suitable length, such as, for example, approximately 2 inches. It will be appreciated that the widths of the necked portion 144 and the notches 142, 143 in the parent stored-value card 104 are not limited to the values recited above, and the necked portion 144 and the notches 142, 143 may have any other suitable widths. Together, the notch 131 in the carrier shell 102 and the corresponding necked portion 144 of the parent stored-value card 104 define the second security mechanism configured to releasably secure the parent stored-value card 104 to the carrier shell 102.

Although in the illustrated embodiment the stored-value card multipack 100 includes both a first security mechanism (e.g., a security post 130 in the carrier shell 102 and a corresponding aperture 141 in the parent stored-value card 104) and a second security mechanism (e.g., a notch 131 in the carrier shell 102 and a corresponding necked portion 144 in the parent stored-value card 104) to securedly attach the parent stored-value card 104 to the carrier shell 102, in other embodiments the stored-value card multipack 100 may include only the first security mechanism or only the second security mechanism.

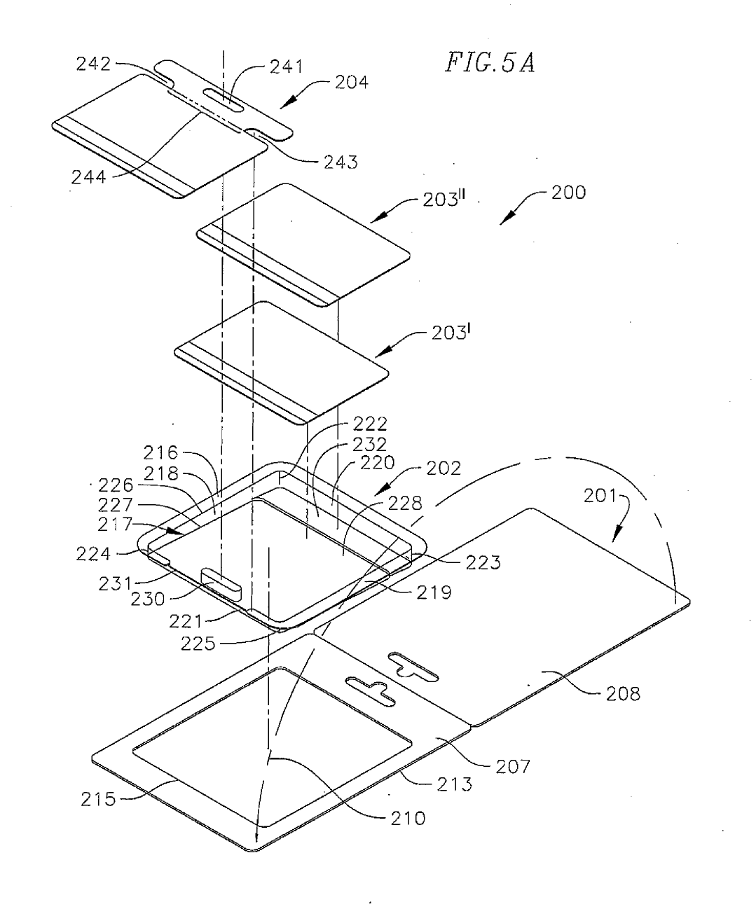

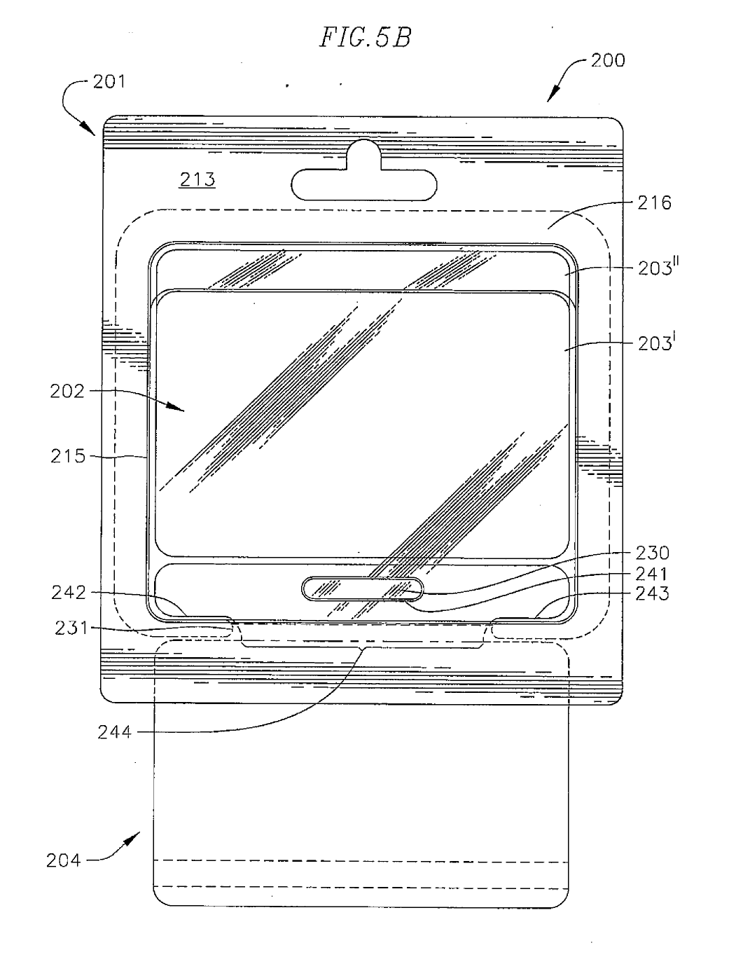

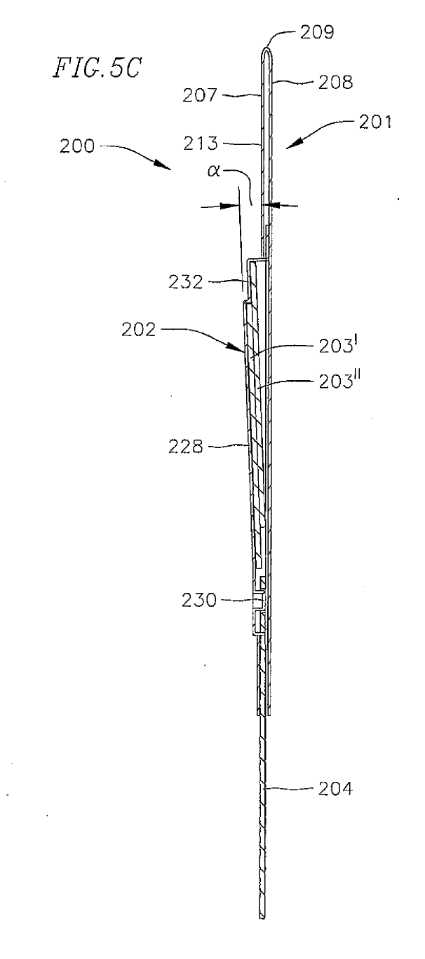

With reference now to FIGS. 5-7, further embodiments of a stored-value card multipack are illustrated. In the illustrated embodiments, the configuration of the carrier shell varies depending upon the number and arrangement of the child stored-value cards housed in the carrier shell. In particular, FIGS. 5-7 illustrate various embodiments of the carrier shell having one or more steps, described below, corresponding to the number of child stored-value cards stored in the carrier shell such that the child stored-value cards are configured to be arranged in a staggered and overlapping arrangement in the carrier shell. It will be appreciated, however, that the carrier shell may have any other suitable configuration depending upon the desired arrangement of the child stored-value cards housed in the carrier shell, such as, for example, in a fanned, stacked, or offset configuration, or any other suitable configuration and arrangement of the child stored-value cards, and still fall within the scope and spirit of the present invention.

With reference now to the embodiment illustrated in FIGS. 5A-5C, a stored-value card multipack 200 includes a carrier base 201, a carrier shell 202 received in an opening 215 in the carrier base 201, two child stored-value cards 203′, 203″ housed in the carrier shell 202, and a parent stored-value card 204 securedly attached to the carrier shell 202. The carrier base 201, the child stored-value cards 203′, 203″, and the parent stored-value card 204 may be similar, or identical, to the carrier base 101, the child stored-value cards 103, and the parent stored-value card 104 described above with reference to the stored-value card multipack 100 and, therefore, will not be described in further detail. The stored-value card multipack 200 may also include one or more security mechanisms for securedly attaching the parent stored-value card 204 to the carrier shell 202 (e.g., a security post 230 on the carrier shell 202 and a corresponding aperture 241 in the parent stored-value card 204 configured to receive the security post 230 and/or a notch 231 in the carrier shell 202 and corresponding notches 242, 243 and a necked portion 244 in the parent stored-value card 204 configured to be received in the notch 231), as described above.

With reference now to FIG. 5A, the carrier shell 202 includes a peripheral flange 216 and a recessed portion 217 protruding from the peripheral flange 216. In the illustrated embodiment, the recessed portion 217 of the carrier shell 202 is defined by two opposing side panels 218, 219 extending in a longitudinal direction and opposing upper and lower panels 220, 221, respectively, extending in a direction transverse to the longitudinal direction. The upper panel 220 interconnects upper ends 222, 223 of the side panels 218, 219, respectively, and the lower panel 221 interconnects lower ends 224, 225 of the side panels 218, 219, respectively. Each of the panels 218, 219, 220, 221 includes an inner end 226 coupled to the peripheral flange 216 and an outer end 227 opposite the inner end 226. The recessed portion 217 also includes a front panel 228 extending between the outer ends 227 of the side panels 218, 219 and the lower panel 221.

In the illustrated embodiment of FIG. 5C, the front panel 228 defines an acute angle α relative to the peripheral flange 216, such as, for example, approximately 10 degrees to approximately 45 degrees. Accordingly, when the stored-value card multipack 200 is assembled, the front panel 228 of the carrier shell 202 defines an acute angle α with respect to a front surface 213 of the front portion 207 of the carrier base 201. Angling the front panel 228 of the carrier shell 202, and thereby angling the stored-value cards 203 housed in the carrier shell 202, may provide a desirable viewing angle for consumers viewing the stored-value card multipack 200 when it is displayed for sale (e.g., when the stored-value card multipack 200 is displayed for sale on a retail rack, angling the front panel 228 of the carrier shell 202 may provide the purchaser with a desirable viewing angle of any printed indicia on the child stored-value cards 203). In an alternate embodiment, the front panel 228 of the carrier shell 202 may not be angled relative to the carrier base 201.

With continued reference to the embodiment illustrated in FIGS. 5A-5C, the carrier shell 202 also includes a step 232 between the front panel 228 and the upper panel 220. In the illustrated embodiment, the step 232 is configured to stagger or offset the child stored-value cards 203′, 203″ housed in the carrier shell 202. In particular, the first child stored-value card 203′ is seated against the inside of the front panel 228 and a portion of the second child stored-value card 203″ is seated against the inside of the step 232 such that an upper portion of the child stored-value card 203″ protrudes above the first child stored-value card 203′ and is thereby visible to a purchaser viewing the cards 203′, 203″ through the carrier shell 202, as illustrated in FIGS. 5B and 5C. Staggering the child stored-value cards 203′, 203″ in the carrier shell 202 enables a customer to readily ascertain the number of child stored-value cards 203′, 203″ housed in the carrier shell 202. Additionally, staggering the child stored-value cards 203′, 203″ in the carrier shell 202 may reveal various printed indicia on the child stored-value cards 203′, 203″, such as ornamentation, text and graphics indicating the balance associated with the card, and/or text and graphics indicating a particular retailer or industry associated with the card.

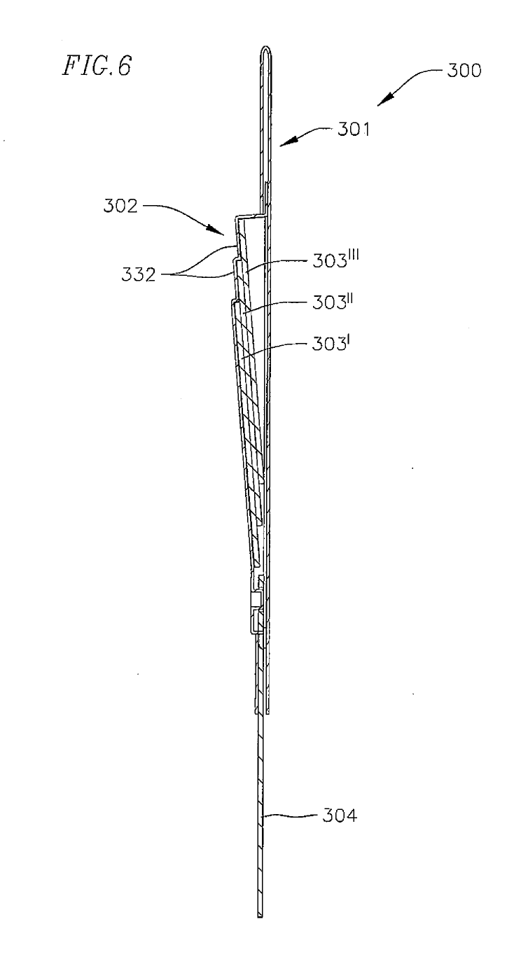

With reference now to the embodiment illustrated in FIG. 6, a stored-value card multipack 300 includes a carrier base 301, a carrier shell 302, three child stored-value cards 303′, 303″, 303′″ housed in the carrier shell 302, and a parent stored-value card 304 securedly attached to the carrier shell 302. The carrier base 301, the child stored-value cards 303′, 303″, 303′″, and the parent stored-value card 304 may be similar, or identical, to the carrier base 101, the child stored-value card 103, and the parent stored-value card 104 described above with reference to the stored-value card multipack 100 and, therefore, will not be described in further detail. The carrier shell 302 may also include one or more security mechanisms to securedly attach the parent stored-value card 304 to the carrier shell 302, as described above. Additionally, the carrier shell 302 is similar or identical to the carrier shell 202 described above with reference to stored-value card multipack 200, except the carrier shell 302 includes two steps 332 and is configured to house three child stored-value cards 303′, 303″, 303′″ in a staggered configuration.

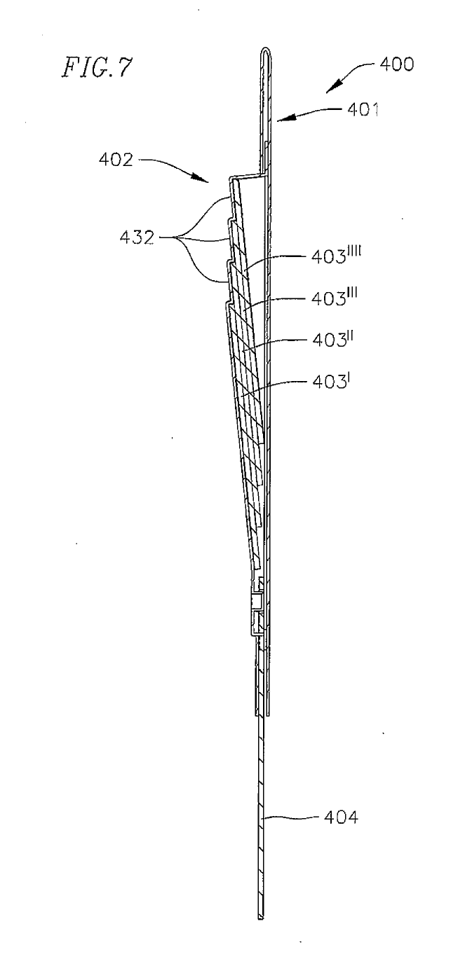

With reference now to the embodiment illustrated in FIG. 7, a stored-value card multipack 400 includes a carrier base 401, a carrier shell 402, four child stored-value cards 403′, 403″, 403′″ housed in the carrier shell 402, and a parent stored-value card 404 securedly attached to the carrier shell 402. The carrier base 401, the child stored-value cards 403′, 403″, 403′41 , and the parent stored-value card 404 may be similar, or identical, to the carrier base 101, the child stored-value card 103, and the parent stored-value card 104 described above with reference to the stored-value card multipack 100 and, therefore, will not be described in further detail. The carrier shell 402 may also include one or more security mechanisms to securedly attach the parent stored-value card 404 to the carrier shell 402, as described above. Additionally, the carrier shell 402 is similar or identical to the carrier shell 202 described above with reference to stored-value card multipack 200, except the carrier shell 402 includes three steps 432 and is configured to house four child stored-value cards 403′, 403″, 403′″ in a staggered configuration.

Although the carrier shell has been described above with reference to one step 232 (FIG. 5), two steps 332 (FIG. 6), and three steps 432 (FIG. 7), it will be appreciated that the carrier shell may have any other suitable number of steps depending on the number and arrangement of the child stored-value cards housed in the carrier shell.

The carrier base 101, 201, 301, 401 of the present invention may be formed from any suitable material, such as, for example, paper, card stock, cardboard, plastic, polyethylene terephthalate (PET), polyvinyl chloride (PVC), polypropylene (PP), polyethylene (PE), polychlorotrifluoroethylene (PCTFE), cyclic olefin copolymers (COC), cyclic olefin polymers (COP), or combinations thereof The carrier shell 102, 202, 302, 402 may be formed from any suitable material, such as, for example, plastic, polyethylene terephthalate (PET), polyvinyl chloride (PVC), polypropylene (PP), polyethylene (PE), polychlorotrifluoroethylene (PCTFE), cyclic olefin copolymers (COC), cyclic olefin polymers (COP), or combinations thereof. In one embodiment, the carrier shell 102, 202, 302, 402 and the carrier base 101, 201, 301, 401 may be made out of the same or similar materials. In another embodiment, the carrier shell 102, 202, 302, 402 and the carrier base 101, 201, 301, 401 may be made out of dissimilar materials. The carrier shell 102, 202, 302, 402 may be formed by any suitable method, such as vacuum forming, thermoforming, molding, welding (e.g., friction stir welding), stamping, pressing, rapid prototyping using additive manufacturing techniques, or combinations thereof. Additionally, although the carrier base 101, 201, 301, 401 and the carrier shell 102, 202, 302, 402 have been described above as separate components, the carrier base 101, 201, 301, 401 and the carrier shell 102, 202, 302, 402 may be integrally formed as a single component.

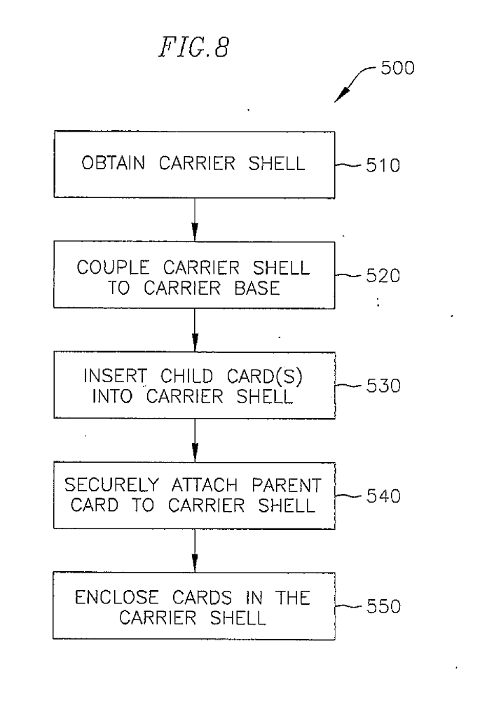

With reference now to the flowchart illustrated in FIG. 8, a method 500 of assembling the stored-value card multipacks 100, 200, 300, 400 of the present invention will now be described. In one embodiment, the method 500 includes a task 510 of obtaining a carrier shell having the desired configuration. The desired configuration of the carrier shell may be determined, in part, by the number of child stored-value cards to be housed in the carrier shell and the desired arrangement of the child stored-value cards in the carrier shell, such as, for instance, in a stacked, fanned, or staggered arrangement. For instance, the carrier shell may include a single step 232 and house two child stored-value cards 203′, 203″ in a staggered configuration (see FIG. 5A), or two steps 332 and house three child stored-value cards 303′, 303″, 303′″ in a staggered configuration (see FIG. 6), or three steps 432 and house four child stored-value cards 403′, 403″, 403′″, 403″″ in a staggered configuration (see FIG. 7). The method 500 also includes a task 520 of coupling the carrier shell to a carrier base. In one embodiment, the task 520 of coupling the carrier shell to the carrier base includes inserting a portion of the carrier shell through the opening in the front portion of the carrier base. When the carrier shell is inserted into the opening in the carrier base, the recessed portion of the carrier shell protrudes beyond the outer surface of the front portion of the carrier base. Additionally, when the carrier shell is inserted into the opening in the carrier base, the peripheral flange on the carrier base overhangs the front portion of the carrier base and abuts the inner surface of the front portion of the carrier base.

The method 500 also includes a task 530 of inserting the one or more child stored-value cards into the recessed portion of the carrier shell. The method 500 may also include applying removable adhesive to one or more of the child stored-value cards to retain the child stored-value cards in the recessed portion of the carrier shell. The method 500 also includes a task 540 of securedly attaching the parent stored-value card to the carrier shell. In one embodiment, the task 540 of securedly attaching the parent stored-value card to the carrier shell includes inserting the security post on the carrier shell through the aperture in the detachable tab portion of the parent stored-value card. In one embodiment, the task 540 of securedly attaching the parent stored-value card to the carrier shell may also include inserting the necked portion of the parent stored-value card into the notch in the carrier shell such that a portion of the lower panel on the carrier shell extends into the notches in the parent stored-value card.

The method 500 also includes a task 550 of enclosing the stored-value cards in the carrier shell. In one embodiment, the task 550 of enclosing the stored-value cards in the carrier shell includes folding the rear portion of the carrier base about the fold line such that the inner surface of the rear portion abuts the inner surface of the front portion of the carrier base. When the carrier base is folded about the fold line, the peripheral flange on the carrier shell is disposed between the front and rear portions of the carrier base. Additionally, when the carrier base is folded, the detachable tab portion of the parent stored-value card is disposed between the front and rear portions of the carrier base. In another embodiment, the task 550 of enclosing the stored-value cards in the carrier shell includes attaching a rear carrier base member to a front carrier base member. The task 550 of enclosing the stored-value cards in the carrier shell may also include a task of sealing the carrier base together (i.e., the rear portion of the carrier base may be sealed to the front portion of the carrier base). The carrier base may be sealed together by any suitable means, such as, for example, applying adhesive to a portion of the carrier base before folding the carrier base about the fold line, heat sealing the carrier base, ultrasonic welding, mechanical fastening, or any combinations thereof.

The store-value card multipacks 100, 200, 300, 400 of the present invention may be assembled using an automated system. Suitable automated systems for assembling card multipacks are disclosed in U.S. Patent Application Publication No. 2012/0234909, entitled “Automated System and Method for Constructing Card Multipacks,” the entire contents of which are hereby incorporated by reference.

To use the stored-value card multipacks 100, 200, 300, 400 of the present invention, the user first purchases the stored-value card multipack 100, 200, 300, 400 from a merchant. The merchant activates the parent stored-value card 104, 204, 304, 404 by reading the readable code on the parent stored-value card 104, 204, 304, 404 (e.g., swiping the magnetic stripe through a magnetic card reader, scanning the RFID chip with an RFID chip reader, scanning the barcode, or entering the alphanumeric sequence into a keypad). As described above, the readable code on the parent stored-value card is exposed 104, 204, 304, 404 (i.e., not housed in the carrier shell 102, 202, 302, 402) to facilitate ease of activation of the parent stored-value card 104, 204, 304, 404. Moreover, the readable code on the parent stored-value card 104, 204, 304, 404 is associated or linked with the readable codes on the child stored-value cards 103, 203, 303, 403 in a data file typically maintained by a data processing company. Accordingly, when the parent stored-value card 104, 204, 304, 404 is activated, the linked child stored-value cards 103, 203, 303, 403 are also automatically activated. After the stored-value cards have been activated, the user may remove the child stored-value cards 103, 203, 303, 403 from the carrier shell 102, 202, 302, 402, such as, for example, by tearing away the carrier base 101, 201, 301, 401. The user may also detach the parent stored-value card 104, 204, 304, 404 from the carrier shell by disengaging the one or more security mechanisms (e.g., by lifting the parent stored-value card off of the security post on the carrier shell and/or lifting the necked portion of the parent stored-value card out of the notch in the carrier shell). After the parent stored-value card has been detached from the carrier shell, the detachable tab portion of the parent stored-value card 104, 204, 304, 404 may be removed (e.g., by snapping off the detachable tab portion). The balances associated with the stored-value cards may then be redeemed at any participating retailer.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” “vertical, “horizontal” and similar terms have been used herein to describe a spatial relationship of one element to another, it is understood that these terms are intended to encompass different orientations of the various elements and components of the device in addition to the orientation depicted in the figures.

Additionally, although the stored-value card multipacks 100, 200, 300, 400 of the present disclose have been described with reference to a parent card 104, 204, 304, 404, respectively, in one or more alternate embodiments, the stored-value card multipacks 100, 200, 300, 400 may include a carrier member instead of the parent card 104, 204, 304, 404. Like the parent cards 104, 204, 304, 404 described above, the carrier members may have a readable code (e.g., a barcode, a magnetic stripe, an RFID chip, or an alphanumeric character sequence) associated with the readable codes on the child cards 103, 203′, 203″, 303′, 303″, 303′″, 403′, 403″, 403′″ such that when the carrier member is activated (e.g., by swiping the magnetic stripe on the carrier member at the time of purchase), each of the child cards linked or associated with the carrier member are automatically activated without requiring separate activation of each of the child cards. However, unlike the parent cards described above, the carrier members may have no redeemable balance stored thereon or associated with the carrier member itself (e.g., in one embodiment, a stored-value card multipack includes a carrier member used to activate one or more associated stored-value child cards, but the carrier member itself is not a stored-value card because there is no redeemable balance stored thereon or associated with the carrier member).

What is claimed is:

1. A stored-value card multipack, comprising:
a carrier base;
a carrier shell coupled to the carrier base, the carrier shell and the carrier base defining a cavity;
a first card housed in the cavity; and
a second card detachably coupled to the carrier shell by a mechanical security mechanism, the second card extending out of the cavity and thereby exposing a readable code on the second card.

2. The stored-value card multipack of claim 1, wherein the mechanical security mechanism comprises:
a security post protruding from the carrier shell; and
an aperture in the second card configured to detachably receive the security post.

3. The stored-value card multipack of claim 1, wherein the mechanical security mechanism comprises:
a notch in the carrier shell; and
a pair of opposing notches in the second card, the pair of opposing notches defining a necked portion configured to be detachably received in the notch in the carrier shell.

4. The stored-value card multipack of claim 1, wherein the first card comprises a child stored-value child, the second card comprises a parent stored-value card, and balances associated with the child stored-value card and the parent stored-value card are linked by a data file such that activation of the parent stored-value card automatically activates the child stored-value card.

5. The stored-value card multipack of claim 1, wherein the second card comprises a body portion and a detachable tab portion extending from the body portion, the detachable tab portion housed in the cavity and the body portion located outside the cavity.

6. The stored-value card multipack of claim 1, wherein the second card comprises a body portion and a detachable tab portion extending from the body portion, the detachable tab portion housed in the cavity and at least a portion of the body portion exposed outside of the cavity.

7. The stored-value card multipack of claim 1, wherein the readable code on the second card is selected from the group consisting of a bar code, a magnetic stripe, a radio-frequency identification card, and an alphanumeric sequence.

8. The stored-value card multipack of claim 1, wherein the carrier base includes a front portion coupled to a rear portion.

9. The stored-value card multipack of claim 8, wherein a portion of the second card is disposed between the front and rear portions of the carrier base.

10. The stored-value card multipack of claim 8, wherein the front portion of the carrier base further comprises an opening configured to receive the carrier shell.

11. The stored-value card multipack of claim 10, wherein the carrier shell comprises a peripheral flange and a recessed portion projecting from the peripheral flange, the recessed portion projecting through the opening in the carrier base and the peripheral flange disposed between the front and rear portions of the carrier base.

12. The stored-value card multipack of claim 2, wherein the shape of the security post is selected from the group of shapes consisting of a circular cylindrical, an oval cylinder, a square prism, a rectangular prism, a pyramid, and an irregular shape.

13. The stored-value card multipack of claim 1, wherein the carrier base comprises a material selected from the group of materials consisting of paper, card stock, cardboard, plastic, polyethylene terephthalate (PET), polyvinyl chloride (PVC), polypropylene (PP), polyethylene (PE), polychlorotrifluoroethylene (PCTFE), cyclic olefin copolymers (COC), cyclic olefin polymers (COP), and combinations thereof.

14. The stored-value card multipack of claim 1, wherein the carrier shell comprises a material selected from the group of materials consisting of plastic, polyethylene terephthalate (PET), polyvinyl chloride (PVC), polypropylene (PP), polyethylene (PE), polychlorotrifluoroethylene (PCTFE), cyclic olefin copolymers (COC), cyclic olefin polymers (COP), and combinations thereof.

15. The stored-value card multipack of claim 1, wherein the carrier shell and the carrier base are integral.

16. The stored-value card multipack of claim 1, wherein the carrier shell is configured to tilt the first card at an angle relative to the carrier base.

17. The stored-value card multipack of claim 1, wherein the carrier shell includes at least one step.

18. The stored-value card multipack of claim 1, further comprising a plurality of cards housed in the carrier shell and arranged in a stacked configuration.

19. A stored-value card multipack, comprising:
a carrier base;
a carrier shell coupled to the carrier base, the carrier shell and the carrier base defining a cavity;
a first card housed in the cavity; and
a second card detachably coupled to the carrier shell by a mechanical security mechanism, the second card extending out of the cavity and thereby exposing a readable code on the second card, wherein the mechanical security mechanism comprises:
a security post protruding from the carrier shell;
an aperture in the second card configured to detachably receive the security post;
a notch in the carrier shell; and
a pair of opposing notches in the second card, the pair of opposing notches defining a necked portion configured to be detachably received in the notch in the carrier shell.

20. The stored-value card multipack of claim 19, wherein the second card comprises a body portion and a detachable tab portion extending from the body portion, the detachable tab portion housed in the cavity and the body portion exposed outside of the cavity.
